(19) United States
(12) Patent Application Publication
(10) Pub. No.: US 2010/0169535 A1
(43) Pub. Date: Jul. 1, 2010

(54) DATA STREAM MANAGEMENT

(75) Inventors: Donald Thomas Saxby, Salt Lake City, UT (US); Colin N.B. Cook, Riverton, UT (US); Joseph Arthur Harris, West Jordan, UT (US)

Correspondence Address: MADSON IP, Old Shepard Commons, Suite 230, 1466 North Highway 89, Farmington, UT, 84025, US

(73) Assignee: Celio Technology Corporation, Salt Lake City, UT (US)

(21) Appl. No.: 12/649,191

(22) Filed: Dec. 29, 2009

Related U.S. Application Data
(60) Provisional application No. 61/141,299, filed on Dec. 30, 2008.

(51) Int. Cl. G06F 13/14

(52) U.S. Cl. 710/316

(57) ABSTRACT

A method for packetizing and communicating data. Data payloads are allocated to data categories based on processing function. A dedicated communication channel is associated with each data category. A data processing header for each channel precedes the data payload in each data communication packet, includes particulars sufficient to support a data processing operation, and is size-independent of the data payload. The header includes a dominant header sized common to all headers and a subdominant header of size defined for each channel, but independent of the data payload. The dominant header includes an operation identifier explicating the purpose of the data payload followed by a payload-size indicator conveying the size the data payload. The data payload may be empty. Dedicated communication channels include a command channel for keyboard and mouse events, a video raster channel, and a mass storage media block channel.

### CROSS-REFERENCED RELATED APPLICATIONS

This application claims the benefit and is a continuation-in-part application of U.S. Provisional Patent Application Ser. No. 61/141,299 that was filed on Dec. 30, 2008.

### BACKGROUND OF THE INVENTION

1. Field of the Invention

The present invention relates to electronic data processing systems that present visual images to users. In particular, the present invention pertains to the management of the flow of electronic data about visual images during the communications that occur among the elements of a data processing system.

2. Background

The miniaturization of electronic circuitry has facilitated the development of hand-held electronic devices, which despite being diminutive in size, embody impressive amounts of computing power and data storage space. Examples include cellular phones, smart phones, personal digital assistants, electronic books, and personal media players.

Such devices are capable of being incorporated by wired or wireless interconnections with other devices as elements of a data processing system.

Yet the management of data being communicated among elements of a data processing system presents continuing challenges.

### BRIEF SUMMARY OF THE INVENTION

According to teachings of the present invention, a method for communicating data among elements of a host device and elements of a client device enables operation of the host device in concert with the client device to make a feature of the client device available to the host device. The host device is a device selected from the group of devices comprising a cellular phone, a smart phone, a personal digital assistant, an electronic book, and a personal media player.

The method includes the steps of identifying data categories among which to allocate all data payloads communicated among the elements of the host device and the client device based on the data processing function to be performed involving each respective data payload, associating individual dedicated communication channels in a set thereof with each data category, defining a data processing header for each dedicated communication channel, commencing each data payload with the data processing header defined for the dedicated communication channel associated with the data category of data in the data payload, and transmitting the data payload with the data processing header attached thereto on the dedicated communication channel associated with the data category of data in the data payload.

The data processing header for each dedicated communication channel include particulars sufficient to support a data processing operation. The size of the data processing header for a given dedicated communication channel is independent of the particular data payload communicated on the given dedicated communication channel. The data processing header defined for each of dedicated communication channel includes a dominant header of a size common to all data processing headers, and a subdominant header having a size of for a given dedicated communication channel that is independent of the particular data payload communicated on the given dedicated communication channel. The dominant header of each data processing header includes an operation identifier explicating the purpose of the data payload following the data processing header, and a payload-size indicator conveying the size of any data in the data payload following the data processing header. The data payload following the data processing header may be devoid of data. The set of dedicated communication channels includes a command channel upon which keyboard and mouse event data payloads are transferred, a video raster channel upon which raster display operations are transferred, and a mass storage channel upon which mass storage media block data is transferred.

In the method, the step of transmitting includes the steps of contacting the host device from the client device offering to conduct a data exchange, accepting the offer to conduct a data exchange by the host device, interconnecting the client device with the host device, and communicating the data payload with the data processing header attached thereto between the host device and the client device. The step of contacting includes the steps of broadcasting from the client device a discovery packet seeking to have the client device placed in communication with the host device, and receiving the discovery payload at the host device. The step of interconnecting includes the steps of connecting the client device to the host device, and coupling the host device to the client device.

In another aspect of the present invention, a method for packetizing and communicating data among elements of a data processing system commences by organizing the data into data payloads. Then each individual member in a set of dedicated communication channels is associated with individual data categories among which all data payloads are allocated based on a data processing function to be performed by the data processing system involving data in each data payload. To the leading end of each data payload a data processing header is attached that includes particulars sufficient to support a data processing operation involving the data payload. The size of the data processing header for a given dedicated communication channel is independent of the particular data payload communicated on the given dedicated communication channel. Data payloads with a corresponding data processing header attached are then transmitted on the dedicated communication channel associated with the data category of the data contained in each respective data payload. The set of dedicated communication channels includes a command channel, a video raster channel, and a mass storage channel, all as described above.

The step of attaching includes positioning at the leading end of the data payload an operation parameters field having a size independent of the particular data payload communicated on the dedicated channel corresponding to the category of data of the type contained in the data payload and advising of conditions associated with data processing operations involving data in the data category of the data contained in the data payload, locating at the leading end of the operation parameters field a payload-size indicator conveying the size of the data in the data payload, and disposing at the leading end of the payload-size indicator an operation identifier explicating the purpose of the data payload. The operation identifier and the payload size field in combination function as a dominant portion of the data processing header, and the size of the dominant portion of the data processing header is independent of the particular data payload communicated on the given dedicated communication channel. A data processing header is defined for each of the dedicated communication channels, and the size of the data processing header for a given dedicated communication channel is independent of the particular data payload communicated on the given dedicated communication channel.

Also, according to teachings of the present invention, a host device is operable in concert with a client device to make a feature of the client device available to the host device. The host device includes a communication module capable of engaging in data stream communications with the client device, a processor coupled to the communication module, and a memory structure accessible to the processor. The memory structure houses executable code that operates on the processor to cause the processor to configure data for transmission to the client device as a data payload immediately preceded by a data processing header that is definitive of an individual dedicated communication channels in a set of dedicated communication channels, each of which is associated with data categories where among are allocated all data payloads based on a data processing function to be performed involving each respective data payload. The set of dedicated communication channels includes a command channel, a video raster channel, and a mass storage channel, each of the type earlier set forth.

The data processing header produced according to the executable code in the host device includes an operation identifier explicating the purpose of the data payload following the data processing header, a payload-size indicator following the operation identifier, the payload-size indicator conveying the size of any data in the data payload following the data processing header, and an operation parameters segment following the payload-size indicator. The operation parameters segment advises of conditions associated with data processing operations involving data of the category of data contained in the data payload and transmitted on the dedicated communication channel corresponding thereto. The operation identifier and the payload-size indicator together function as a dominant portion of the data processing header, and the size of the dominant portion of the data processing header is independent of the particular data payload communicated on the dedicated communication channel corresponding to the category of data contained in the data payload. Furthermore, the size of the data processing header defined for each of the dedicated communication channels is independent of the particular data payload communicated on the given dedicated communication channel. The data payload preceded by the data processing may be is empty, in which case payload-size indicator is zero, and the data processing header alone constitutes a complete data communication packet.

### BRIEF DESCRIPTION OF THE SEVERAL VIEWS OF THE DRAWINGS

In order that the manner in which the above-recited and other features and advantages of the present invention are obtained will be readily understood, a more particular description of the present invention briefly described above will be rendered by reference to specific embodiments thereof which are illustrated in the appended drawings. Understanding that these drawings depict only typical embodiments of the present invention and are not therefore to be considered to be limiting of scope thereof, the present invention will be described and explained with additional specificity and detail through the use of the accompanying drawings in which:

FIG. 1 is a perspective view of an exemplary embodiment of a system involving a set of client devices and a hand-held host device that operate in concert to efficiently communicate and process data according to teachings of the present invention;

FIG. 2 is an overview schematic diagram of the client devices and selected elements of the host device from FIG. 1;

FIG. 3 is a diagram at various levels of specificity of a method incorporating teachings of the present invention by which to assemble and transmit graphics data in packetized units during the operation of the host device and the set of client devices shown in FIG. 1;

FIG. 4 is a flow chart of steps in a first embodiment of a method incorporating teachings of the present invention for communicating data among elements of a data processing system, such as the system shown in FIG. 1 to include a host device and a set of client devices;

FIG. 5 is a flow chart of steps in a second embodiment of a method incorporating teachings of the present invention for communicating data among elements of a data processing system.

### DETAILED DESCRIPTION OF THE INVENTION

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in FIGS. 1-5, is not intended to limit the scope of the invention, as claimed, but is merely representative of presently preferred embodiments of the invention.

FIG. 1 depicts a typical environment in which teachings of the present invention find utility. A user 10 at a desk 12 is operating an exemplary embodiment of a set or system 14 made up of peripheral devices that employ methodology incorporating teachings of the present invention to enhance selected of the functions routinely available in a hand-held host device 16 that rests on desk 12. Host device 16 is possessed of substantial computing power and data storage space, but due to the small size thereof, host device 16 has a relatively small physical display and is awkward to control. Examples of typical hand-held devices like host device 16 include cellular telephones, smart telephones, personal digital assistants, electronic books, and personal media players.

System 14 enables user 10 to communicate data from host device 16 to various client devices distinct therefrom, such as the client devices in set or system 14. In this manner user 10 is able to view in an enlarged format on a full-size output device, such as monitor 18, an image 20 the details of which might otherwise not be discernible to user 10, when exhibited on a visual display 22 that is built into host device 16. Included in system 14 is a full-size input device in the form of a keyboard 24, which allows user 10 to control system 14 without resorting to miniature keys 26 that are carried directly on host device 16. Thus, system 14 includes a set of I/O devices 28 that includes monitor 18 and keyboard 24.

Data originates in host device 16, but in the interests of maintaining the security of host device and any such data therein, it is system 14 that initiates communications between host device 16 device and system 14 by conducting a mutually enacted discovery-and-connect process that will be discussed in detail subsequently.

The ability of user 10 to benefit from I/O devices 28 in system 14 is dependent on another element of system 14, an enhancer 30 for host device 16. Enhancer 30 is a structure distinct from host device 16 that communicates with host device 16 on an enhancer cable 32. Alternatively, a host device, such as host device 16, can effect wireless-type communications with enhancer 30. Enhancer 30 is electrically coupled to monitor 18 by a monitor cable 34, and to keyboard 24 through a keyboard cable 36. Enhancer 30 converts data obtained from host device 16 into data suitable for use by I/O devices 28, such as monitor 18 and keyboard 24.

In view of the relationship existing between host device 16 and system 14, monitor 18, keyboard 24, and enhancer 30 of system 14 are referred to herein on occasion individually or collectively as “client” devices, or alternatively as “elements” of a client system.

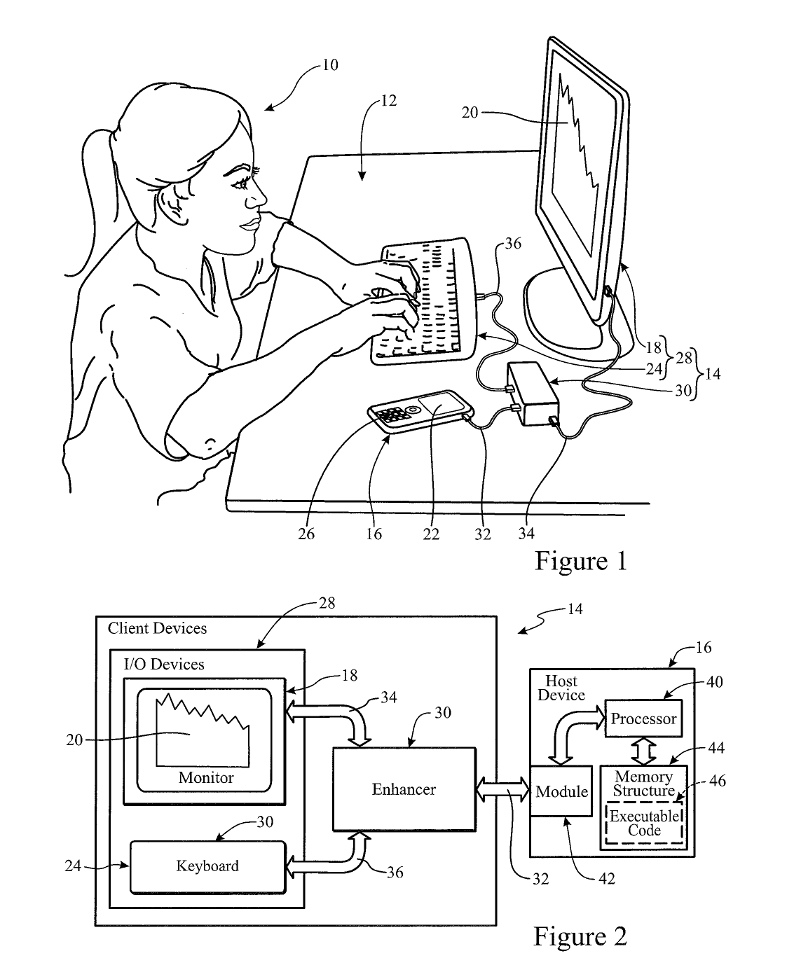

FIG. 2 is a schematic diagram of system 14 from FIG. 1 and selected constituents of host device 16. Host device 16 can be seen, for example, to include a processor 40 and a communication module 42 that is coupled thereto. Communication module 42 is capable of engaging in data stream communications with the client devices of system 14. This occurs with enhancer 30 by way of enhancer cable 32 and through enhancer 30 with the other elements of system 14. In the alternative, in a host device, such as host device 16, a communications module, such as communication module 42, could effect wireless-type communications with enhancer 30.

Host device 16 also includes a memory structure 44 that is accessible to processor 40. Memory structure 44 houses executable code 46 that is operative when on processor 40 to cause processor 40 to configure data for transmission to the client device of system 14 as a data payload immediately preceded by a data processing header. The data processing header is definitive of an individual dedicated communication channel within in a set of dedicated communication channels. Each dedicated communication channel is associated with data categories where among are allocated all data payloads based on a data processing function to be performed involving each respective data payload. Data originating in host device 16 is formatted in this manner by executable code 46 before being moved to enhancer 30.

Other configurations of the elements of system 14 are considered to be within the scope of the present invention. In one such embodiment, enhancer 30 is incorporated with monitor 18 in a single structure that is then connected by individual cables to each of host device 16 and keyboard 24. In another such embodiment, enhancer 26 and keyboard 24 are incorporated into a single structure that is connected by individual cables to each of host device 16 and monitor 18. In yet a final embodiment, enhancer 30, monitor 18, and keyboard 24 are combined in a single structure that is coupled to host device 16 by a single cable. In any of these embodiments, wired intercommunications between or among elements can be replaces as desired or convenient with wireless-type communications.

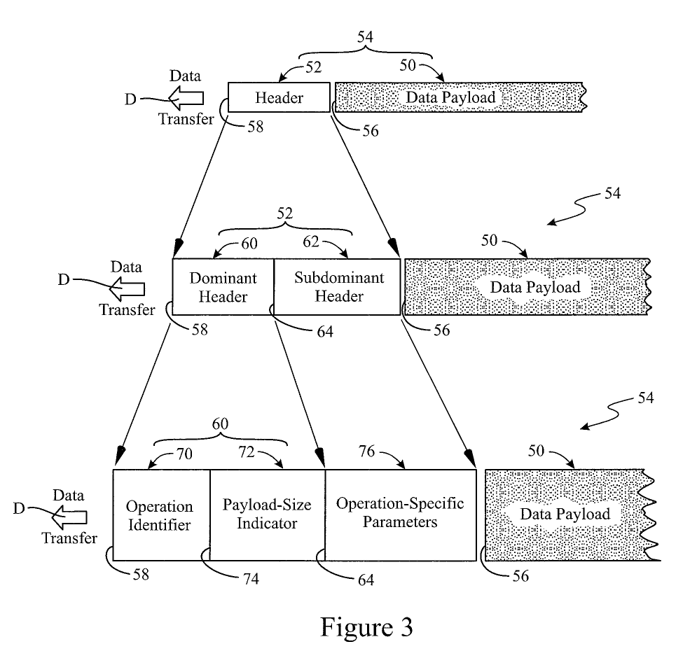

FIG. 3 depicts the formatting implemented upon data in host device 16 by executable code 46 in memory structure 44. A data transfer arrow D indicates the direction in which data is being communicated or transferred.

In the uppermost portion of FIG. 3, a data payload 5 containing data originating in host device 16 is seen to be preceded as data is transfer by a data processing header 52. Data payload 50 and data processing header 52 associated in this manner form a standardized data communication packet 54, a unit in which in the communication of data among the elements of host device 16 and the client devices of system 14 occurs with advantageous efficiency. In light of data transfer arrow D associated with data communication packet 54, data payload 50 has a leading end 56 to which data processing header 52 is attached. Similarly, data processing header 52 has a leading end 58, which is also the leading end of data communication packet 54 when considered as a unit.

Data processing header 52 is intended to contain a strictly formatted set of particulars that, when read properly, serve to define a specific one of several conceptual dedicated communication channels in a set thereof that is employed, according to teachings of the present invention, in organizing the efficient communication of data among the elements of host device 16 and the client devices of system 14. Each dedicated communication channel is correlated to a single specific type, class, or category of possible data that it is anticipated will be contained in data payloads 50 that are to be communicated among elements of host device 16 and elements of system 14. In one embodiment of the present invention, the set of dedicated communication channels includes a command channel whereupon keyboard and mouse event data payloads are transferred, a video raster channel whereupon raster display operations are transferred, and a mass storage channel whereupon mass storage media block data is transferred.

The size of each data processing header 52 for a given dedicated communication channel is independent of the particular data payload 50 communicated, but the overall size of each data processing header 52 is determined by that dedicated communication channel. As seen in the central level of FIG. 3, data processing header 52 includes a dominant header 60 followed by a subdominant header 62. Dominant header 60 is of a size that is common to all data processing headers 52. While the size of subdominant header 62 is independent of the particular data payload 50, the size of subdominant header 62 varies according to the dedicated communication channel that is to be employed for transmission. Subdominant header 62 has a leading end 64 to which data dominant header 60 is attached, and dominant header 60 has a leading end 58, which is also the leading end of data communication packet 54.

Finally, as seen in the lower level of FIG. 3, dominant header 60 includes an operation identifier 70 followed by a payload-size indicator 72. Operation identifier 70 explicates the purpose of data payload 50 that follow data processing header 52, while payload-size indicator 72 conveys the size of any data in data payload 50. Some data communication packets 54 include a data payload 50 that contains no data whatsoever and can be said to be empty. This situation is reflected in payload-size indicator 72 of zero. Payload-size indicator 72 has a leading end 74 to which operation identifier 70 is attached. Similarly, operation identifier 70 has a leading end 58, which is also the leading end of data communication packet 54, data processing header 52, and dominant header 60. The lower level of FIG. 3 also reveals that subdominant header 62 contains operation-specific parameters 76 that pertain to data processing operations involving data of the data category or class associated with the dedicated communication channel on which data communication packet 54 is transmitted.

The present invention includes methods for communicating and processing data within systems that include multiple elements.

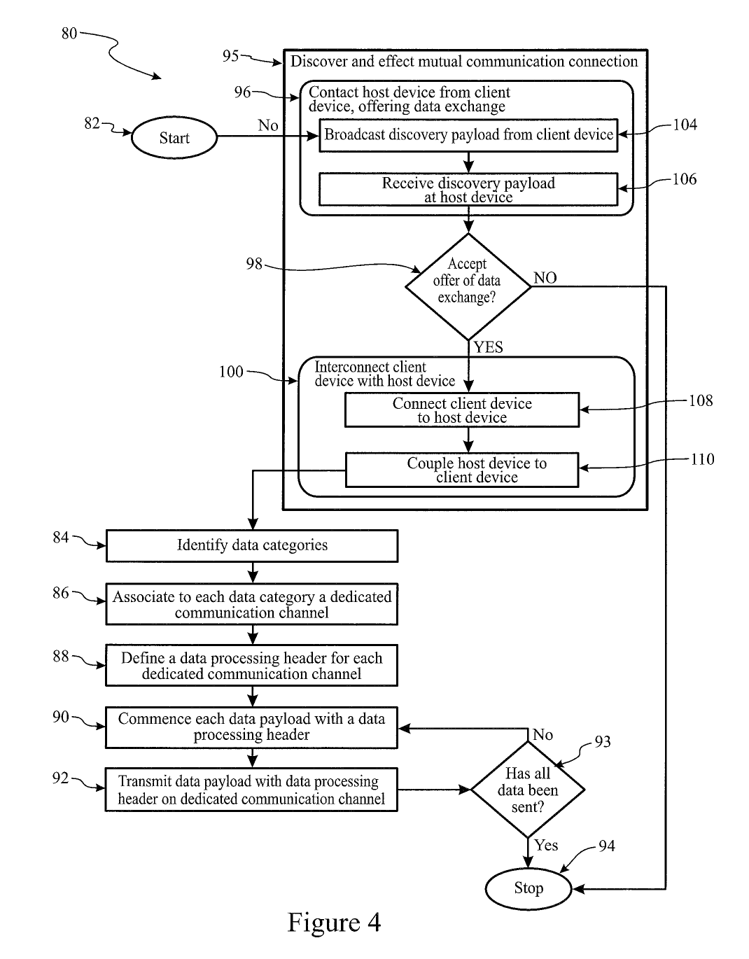

Thus, as presented in FIG. 4, a first embodiment of a method 80 for communicating data among elements of a host device, such as hand-held host device 16, and a client device or system, such as system 14. The operation of the host device in concert with the client device or system according to teachings of the present invention makes a feature of the client device available to the host device.

Method 80 commences at initiation oval 82 with a discovery-and-connect phase thereof, which includes the steps described in the instruction rectangles and the decision diamond enclosed within subroutine rectangle 95. Overall, the process associated with subroutine rectangle 95 involves discovering and effecting a mutual connection between the host device and elements of the client device or system. The process commences by contacting the host device from the client device, offering to conduct a data exchange, as indicated in sub-subroutine rectangle 96. To do so, the client device broadcasts to the host device a discovery packet of specified format that will be discussed in detail subsequently. Then, the offer to conduct a data exchange is either accepted or rejected by the host device, as suggested in decision diamond 98. If the offer is accepted, the client device and the host device become interconnected, as indicated in sub-subroutine rectangle 100. On the other hand, if the host device fails to accept the proffered offer, then the effort to transmit data does not occur, and method 80 concludes in termination oval 94.

The contacting process of sub-subroutine rectangle 96 includes the steps of broadcasting from the client device to the host device the discovery packet mentioned above. The discovery packet seeks in effect for the client device to be placed in communication with the host device, which is indicated in instruction rectangle 104. Correspondingly, the step ensues of receiving the discovery payload at the host device, as indicated in instruction rectangle 106. When in the context of decision diamond 98, the host device accept the proffered offer, the process of sub-subroutine rectangle 100 occurs. First, the client device connects to the host device, as in instruction rectangle 108. Then, the host device connects to the client device, as in instruction rectangle 110. The host device and elements of the client device or system are at this point in method 80 mutually interconnected.

Upon completion of the discovery-and-connect phase of method 80, method 80 continues to a transmission phase thereof, which is reflected in the balance of the instruction rectangles and the remaining decision diamond in FIG. 4.

The discovery-and-connect phase of method 80 begins with the step set forth in instruction rectangle 84 of identifying data categories in which to allocate all data payloads 50 that are to be communicated among the elements of the host device and the client device or system. The data categories are based on the data processing function that is to be performed involving each particular data payload 50. This is followed by the step set forth in instruction rectangle 86 of associating an individual dedicated communication channel with each data category identified in the preceding step. The dedicated communication channels form a finite set, which in one embodiment of a method according to the present invention includes the following: (1) a command channel upon which keyboard and mouse event data payloads are transferred; (2) a video raster channel upon which raster display operations are transferred; and (3) a mass storage channel upon which mass storage media block data is transferred. Additional dedicated communication channels can be employed, provided and associated with corresponding distinct categories of data anticipated in data payloads 50.

Method 80 continues, as indicated in instruction rectangle 88, by defining a data processing header, such as data processing header 52 from FIG. 3, for each of the dedicated communication channels. Like data processing header 52, the data processing header for each dedicated communication channel includes particulars sufficient to fully support a data processing operation of some type. Employing the conceptual preparations involved in the steps associated with instruction rectangle 84, instruction rectangle 86, and instruction rectangle 88, method 80 proceeds as described in instruction rectangle 90, to commence each data payload with the data processing header defined for the dedicated communication channel associated with the data category of data in the data payload. Finally, method 80 proceeds through the process identified in instruction rectangle 92 to transmit each data payload with the corresponding data processing header attached thereto, doing so on the dedicated communication channel associated with the data category of data in the data payload.

If, following the transmission step of instruction rectangle 92, all data intended to be exchanged between the host and client devices has yet to be sent therebetween, then as suggested by decision diamond 93, method 80 returns to the lower portion of the transmission phase thereof and loops through the pair of steps set forth in instruction rectangle 90 and in instruction rectangle 92. Method 80 simply commences each additional data payload with a data processing header, as indicated in instruction rectangle 90, and transmits each additional data payload with its corresponding data processing header attached thereto, as indicated in instruction rectangle 92. This process continues, until all data intended to be exchanged between the host device and the client device has actually been sent.

When all of the data intended to be exchanged between the host device and the client device has been sent, the transmission phase of method 80 ends, and method 80 concludes in termination oval 94.

Therefore, each data communication packet 54 being transferred among the elements of host device 16 and the elements of client system 14 will be configured in the manner depicted in FIG. 3. In this format, the corresponding computer logic required to effectively process the data in data payloads 50 is remarkably streamlined, leading to correspondingly desirable reductions in manufacturing and operating burdens.

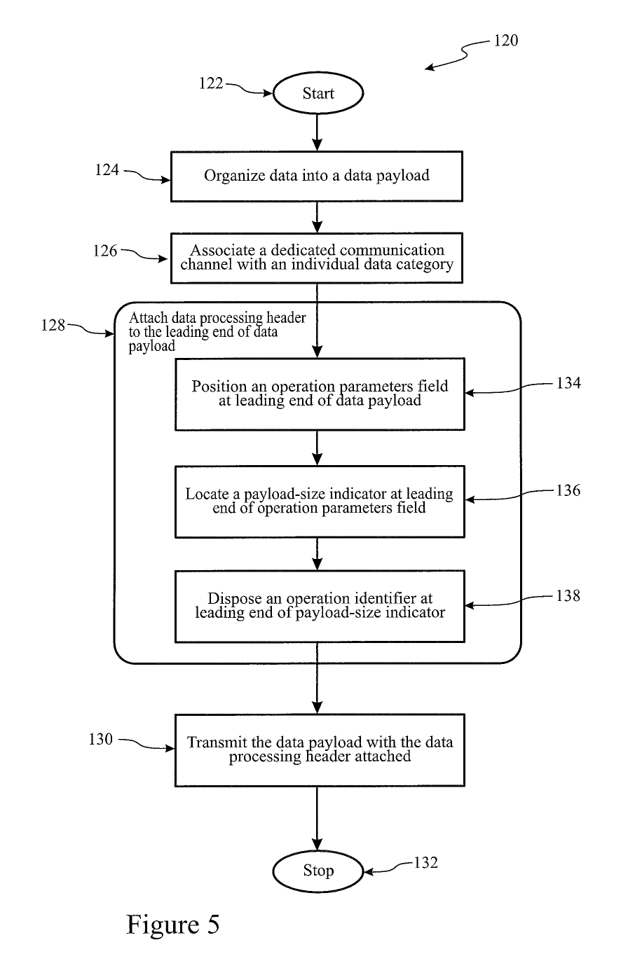

FIG. 5 depicts a second embodiment of a method informed by teachings of the present invention. There a method 120 is depicted for packetizing and communicating data among elements of a data processing system. Commencing at initiation oval 122, method 120 first undertakes to organize data into data payloads, as set forth in instruction rectangle 124, and then instep set froth in instruction rectangle 126 associates a dedicated communication channel with individual data categories correlated to data processing functions performed involving data in a data payload. The dedicated communication channels in one embodiment of method 120 includes a command channel upon which keyboard and mouse event data payloads are transferred; a video raster channel upon which raster display operations are transferred, and a mass storage channel upon which mass storage media block data is transferred. Additional dedicated communication channels may be employed, each associated with corresponding data categories of data anticipated in a data payload.

Following the step of associating corresponding to instruction rectangle 126, method 120 enters the process of subroutine rectangle 128, wherein a data processing header including particulars sufficient to support a data processing operation involving the data payload is attached to the leading end of the data payload. The size of the data processing header for a given dedicated communication channel is independent of the particular data payload communicated on the given dedicated communication channel. At the conclusion of the process of subroutine rectangle 128, method 120 engages in the step of transmitting the data payload with the data processing header attached thereto on the dedicated communication channel associated with the data category of the data contained in the data payload, a step correlated to instruction rectangle 130. Method 120 concludes in termination oval 132.

The attaching process of subroutine rectangle 128 begins in instruction rectangle 134 by positioning at the leading end of the data payload an operation parameters field having a size independent of the particular data payload communicated on the dedicated channel corresponding to the category of data of the type contained in the data payload. The operation parameters field advises of conditions associated with data processing operations involving data in the data category of the data contained in the data payload. Then method 120 and the attaching process of subroutine rectangle 128 continues, as indicated in instruction rectangle 136, by locating at the leading end of the operation parameters field a payload-size indicator that conveys the size of the data in the accompanying data payload 50. Finally, in instruction rectangle 138, the attaching process of subroutine rectangle 128 concludes by disposing at the leading end of the payload-size indicator an operation identifier explicating the purpose of the associated data payload. The result should take a form similar to that of data communication packet 54 shown in the lower level of FIG. 3.

By way of recapitulation, a the present invention entails a protocol for structuring data communication packets, such as data communication packet 54 discussed relative to FIG. 3. The use of the data packet protocol enables efficient directing of data over a streaming interface as, for example, an interface taking the from of enhancer cable 32 that interconnects host device 16 and system 14 of client devices in FIG. 1. In this respect, the protocol can be considered to be a remote protocol, because while implemented by executable code 46 carried in memory structure 44 of host device 16, the protocol superintends the interactions and overall operation of enhancer 30 and I/O devices 28, which include monitor 18 and keyboard 24.

The balance of the present disclosure will detail an exemplary embodiment of the techniques employed in the remote data protocol and illuminate selected of the benefits accruing from the implementation thereof. The exemplary embodiment is one used in an enhancing device or system, such as the elements of client system 14, that communicates with an enhanced device, such as host device 16, in such a way that one or more features of the enhancing device, such as ease of manipulation or ease of visualization, is made available to the enhanced device. The enhanced device, host device 16, may take the form of a cellular telephone, a smart telephone, a personal digital assistant, an electronic book, or a personal media player.

The structure of the remote data protocol is guided by some fundamental conceptions. First, a dedicated communication channel is established for each particular data class of data payloads anticipated to be processed using the protocol. Each dedicated communication channel may be full or half-duplex, how ever required by the nature of the data class corresponding thereto. The lower-level protocols that are used to transfer data communications packets structured according to the remote data protocol are reliable, unless specified otherwise.

Data communication packets structured according to the remote data protocol begin with a packet header, such as data processing header 52 from FIG. 3. Every data processing header begins with an operation identifier followed by a payload-size indicator, and then a set of operation-specific parameter. These advise any receiving element of a data processing system of the intended use of the data contained in the associated data payload, the dimension of that data, and the conditions under which an operation is to be conducted involving that data. The data processing header is not included in determining the size of a data communication packet. Only the size of data payload that follows the data processing header determines payload-size indicator in a data processing header.

Data processing headers conform to the big-endian network byte order. Each data processing header has a fixed sizes with respect to the dedicated communication channel on which data of the data class contained in the following data payload is communicated. In each instance that a protocol connection is negotiated, the corresponding protocol version is relayed.

The remote data protocol uses an abstraction that is referred to herein and in the appended claims as a dedicated communication channel. A unique dedicated communication channel is associated with each data class of data that is anticipated to be communicated during data processing. For example, if keyboard or mouse input information is considered a specific category of data, then any keyboard or mouse input information would be transferred on a corresponding dedicated communication channel, known to both the sender and the receiver of the keyboard and mouse input information, as a data payload in a data communication packet structured according to the remote data protocol disclosed herein. The remote protocol is a guide for structuring and directing streaming data. The dedicated communication channel abstraction is required to implement lower-level protocols. In the case of transferring the remote protocol over an internet connection, a transmission control protocol port can be used to indicate a unique communication channel. Other lower-level transport protocols may need to implement the mid-level protocols that support such a necessary feature.

Every dedicated communication channel has implied requirements and behavior for the particular data class of data being transferred under the protocol. Such requirements might include packet format, packet size, and a full-duplex channel indication. For example, keyboard data is reasonably easy to represent in a small number of bytes; so a packet definition for a keyboard communication channel may only require approximately 4 bytes and take a specific form that suits the data type. A keyboard will not only send key information, but will also likely receive information, for example to update a status indication on a light emitting diode. Therefore, a full-duplex capacity would need to be required on the associated dedicated communication channel. For video data, by contrast, the packet definition will need to be larger in size in order to describe complicated video operations. Having specific requirements of these types relative to a specific individual dedicated communication channel imparts greater flexibility and affords opportunities for optimization that are not available when global data structuring constraints are implemented across an entire protocol.

The data communication packet definition for each dedicated communication channel is typically just the packet header. The protocol nomenclature of the packet definition is the packet header. In general, a complete packet header is able to fully depict all particulars that are required to support a data operation. In such cases, the packet header is the full data packet definition, as the packet header can act as a heading for other data that is to be included in a packetized unit of transfer data.

A complete data processing header begins with an operation identifier that explicates the contents and the purpose of the associated data packet, followed by a payload-size indicator that advises of the presence or absence of data following the fixed size of the data processing header. This portion of the data processing header is designated as the dominant data processing header. The remaining fraction of the data processing header is designated as the subdominant data processing header. The dominant segment of the data processing header has a constant size of 4 bytes. In the dominant data processing header, the operation identifier is a single byte, and the payload-size indicator is 3 bytes, or 24 bits. The dominant data processing header is a convention that is shared among all data processing headers, regardless of the dedicated communication channel to which each might pertain. The subdominant data processing header has a fixed size that is based on the dedicated communication channel upon which the associated data payload is transferred. For example, a first hypothetical communication channel A might have a fixed subdominant data processing header size of 8 bytes, while a second hypothetical communication channel B might have a fixed subdominant data processing header size of 24 bytes. A typical channel-specific data processing header was discussed relative to data communication packet 54 in FIG. 3.

All data processing headers follow the network byte-order convention. Thus, all bytes, or bit octets, in a packet field that represent integer values that require more than one byte of storage will be ordered from most significant byte to least significant byte. The delineated fields of the subdominant portion of the data processing header may also take advantage of bit packing to reduce the overall size of the data processing header.

The disclosed remote data processing protocol has several advantages.

The sending and the receiving of data that is categorized according to the remote protocol structure and methodology simplifies processing logic and increases system design flexibility. Using the disclosed remote data processing protocol to send and to receive data payloads on specific dedicated communication channels is also beneficial. Dedicated communication channels can be prioritized individually, depending on the features of the underlying transport protocol. Dedicated communication channels serve to organize the classes of data being transferred, and dedicated communication channels can individually define unique data communication packet structures that are optimized to the type of data being transferred thereon.

The remote protocol data processing header structure itself has advantages. The data processing header can be an entire data communication packet definition and yet also function as a header for data payloads. The first 4 bytes of the data processing header act as an operation identifier, and the following payload-size indictor allows the receiver of a data communication packet quickly to parse and dispatch accompanying incoming data payloads, and promptly to discard data payloads deemed irrelevant under the protocol. Finally, under the disclosed remote data communication protocol, data processing headers advantageously follow existing network byte order conventions and support conventional bit packed data fields.

The exemplary remote protocol disclosed defines and operates with efficient successfulness using the following three data-specific, dedicated communication channels:
(a) Command channel: a full-duplex channel used for transferring keyboard and mouse event packets, configuration messages, and notification messages;
(b) Video raster channel: a half-duplex channel used for transferring raster display operations; including image transfers and drawing primitives, such as lines and rectangles; and
(c) Mass storage channel: a full-duplex channel used for transferring mass storage media block data; including read and write requests with completion and status information.
   The disclosed remote protocol can, nonetheless, support additional data-specific, dedicated communication channels in different environments of operation.

The remote data processing protocol is beneficially susceptible to being delivered over various transfer protocols. An obvious example would be the transfer communication protocol of the internet, as that transfer protocol supports connections to separate ports that can be made analogous to the dedicated channels of the remote protocol. The underlying transfer protocol should not be limited by packet size and should include a reliability connection to guarantee data packet delivery.

As the remote protocol can use TCP/IP and even a sockets style API to accomplish communication, RNDIS is also a candidate for communication over USB. For USB, the RNDIS transport encapsulates NDIS messages similar to the semantics of the NDIS miniport driver interface over USB. RNDIS is described in higher detail subsequently herein. The remote protocol can also be transferred over RFCOM, L2CAP, and other protocols, if requirements are sound. In the case of transferring channel-based data packets over RFCOM or L2CAP, additional mid-level protocols have been implemented to multiplex multiple communication channels over a single connection. Such additional packet wrapping includes the communication channel identifier in every transfer unit. The mid-level protocol for RFCOM and L2CAP is not considered proprietary information and is publicly available upon request from Celio Technology Corp. of Salt Lake City, Utah.

The remote protocol implements a client-to-host connection pattern. This pattern enables a capacity for the host to be discovered. Depending on the underlying transfer protocol, the remote protocol host will dispatch discovery packets that allow a listening host to acknowledge and respond to the request. In one example, discovery packet includes the following:
(a) a unique bit pattern that the remote protocol accepts as a discovery packet;
(b) a protocol version that specifies the revision of the remote protocol to be used;
(c) connection-specific features that are requested for the protocol;
(d) host hardware version information; including the firmware revision and platform type;
(e) a requested video screen mode of operation, such as the degree of screen resolution; and
(f) the number of available video screen buffers.
   The broadcasting of the discovery packet may be supplanted by other mechanisms of the fundamental transfer protocol, such as RFCOM or L2CAP, which have built-in services for discovery and connection. In these circumstances, the discovery packet would be used for conveying connection details of the protocol.

The discovery packet, which is 40 bytes in length, deviates from a traditional channel packet by not include the 4 byte dominate header. The reason for omitting the dominate header is related to the manner in which the discovery packet can be transferred. For example, in the case of a sockets based implementation, the discovery packet will be transferred using a UDP-type transfer broadcast packet wherein all bytes required must be read in one step, and the failure to read all requested bytes can result in the loss of an entire data packet.

Table 1 below presents descriptions of the discovery packet.

TABLE 1
Discovery Packet

| FUNCTION | BYTE NO. | CONTENT |
|---|---|---|
| Unique | 0 | Hexadecimal value 43 |
| Pattern | 1 | Hexadecimal value 65 |
| | 2 | Hexadecimal value 6C |
| | 3 | Hexadecimal value 69 |
| | 4 | Hexadecimal value 6F |
| | 5 | Hexadecimal value 44 |
| | 6 | Hexadecimal value 2E |
| Protocol | 7-10 | Current Protocol version expressed in |
| Version | | 32-bit value |
| Screen | 11 | Screen resolution and Screen rotation |
| Mode | | |
| Connection | 12 & 13 | Identifies which channel to use. |
| Features | | |
| Device ID | 14 | Platform type |
| | 15-17 | Unit serial number |
| Host Ports | 18 & 19 | Command port ID |
| | 20 & 21 | Video port ID |
| | 22 & 23 | Mass storage port ID |
| Reserved | 24-33 | Reserved |
| Firmware | 34 | Major version |
| Version | 35 | Minor version |
| | 36 | First 4 bits of byte No. 36 contain patch |
| | 37 | Last 4 bits of byte No. 36 and all of byte |
| | | No. 37 contain revision information |
| Video | 38 | Count of available screen buffers |
| Buffers | | addressable by video raster commands |
| End Mark | 39 | Hexadecimal value 00 |

The connection sequence follows the pattern depicted in subroutine rectangle 92 in FIG. 4. Disconnection is accomplished by using features of the underlying transfer protocol, or by explicit control using the remote protocol. A wireless link is gracefully closed by the host or the client. A transfer protocol disconnection sequence may be initiated, such as the disconnection sequence of the TCP/IP. The remote protocol host may receive a disconnect command, which in turn will invoke one of the disconnection methods mentioned above.

When a transfer protocol link is lost, the transfer protocol will report that the connection is dead. When the remote protocol is being transferred over a TCP/IP network, such as RNDIS, the discovery packet should be sent to the client as a UDP broadcast packet to port number 63880.

Table 2 below is an example of code employable for connecting over TCP/IP sockets API.

TABLE 2
Pseudo Code for connecting using TCP/IP sockets API

```
Begin:
  Set Discovery_packet
    ; use command, video, mass storage channels
```

| Discovery_packet.ConnectionFeatures | = 01h + 02h + 04h |
|---|---|
| Discovery_packet.CommandPortId | = 63000 |
| Discovery_packet.VideoPortId | = 63001 |
| Discovery_packet.MassPortId | = 63002 |

```
    ; set remaining fields appropriately
  Create UDP_broadcast_socket
  Create TCP_command_socket on port 63000
  Create TCP_video_socket on port 63001
  Create TCP_mass_socket on port 63002
BroadcastDiscoveryPacket:
  Send Discovery_packet on UDP_broadcast_socket to client port
  63880
  Wait for 250 milliseconds for connection on TCP_command_socket
  If TCP_command_socket accept times out goto
BroadcastDiscoveryPacket
ConnectRemainingSockets:
  Destroy UDP_broadcast_socket
  Accept connection on TCP_video_socket
  Accept connection on TCP_mass_socket
StartThreads:
  Start thread for TCP_command_socket
  Start thread for TCP_video_socket
  Start thread for TCP_mass_socket
  Wait for disconnect on TCP_command_socket or TCP_video_socket
  Stop threads
CleanUp:
  Destroy TCP_mass_socket
  Destroy TCP_video_socket
  Destroy TCP_command_socket
End:
```

In the exchange of messages, the remote protocol uses conceptual separate dedicated communication channels. In the disclosed embodiment, the remote protocol implements a command channel, a video raster channel, and a mass storage channel. The command channel is used to send configuration messages, status messages, mouse-style input messages, and keyboard key-press and state messages. The video raster channel is used to send graphics primitive messages that are used to reconstruct the contents of a visible screen from a client device. The graphics primitive messages include operations for drawing lines and rectangles, as well as draw images transferred in a variety of formats. The mass storage channel is used to send storage media data blocks to be written to storage media or read from storage media. The block device data is in turn converted into useful file-system data that is used by the host device. Each channel serves to fulfill certain needs based upon the category of data that is being distributed. The format of the data exchange for each of the dedicated communication channels will be described in detail subsequently.

The format of a typical data communication packet 54 is set forth in FIG. 3. There the command operation portion of data processing header 52 is located at leading end 58 of dominant header 60 in the form of single-byte operation identifier 70. This is followed by a 3-byte indicator of the size of the data in data payload 50. The indicator of size takes the form of payload-size indicator 72. This is followed by a 4-byte statement of the applicable operation parameters governing data processing operations in the data class applicable to the data in data payload 50. The applicable operation parameters are included in subdominant header 62, taking the form of operation-specific parameters 76. Thereafter follows data payload 50 containing the N-bytes of data forecasted in payload-size indicator 72.

Table 3 below presents descriptions of selected of command operations for the command format packet header.

TABLE 3
Command Operations usable with Command formatted packet

| BYTE | | |
|---|---|---|
| VALUE | NAME | FUNCTION |
| 02h | Mouse Report | Pointing device position and button |
| | | status |
| 03h | Keyboard Report | Keyboard key press and shift state |
| 05h | Media Notification | Mass storage media insert/remove |
| | | notification |
| 06h | Battery Status | Current device battery status |
| 07h | Screen Resolution | Sets device screen resolution |
| 08h | Power Management | Sets device power management settings |
| 09h | Input Settings | Sets device input device settings |
| | | (keyboard/mouse) |
| 0Ah | Cursor Control | Sets device cursor shape |
| 0Bh | Unit Info | Device identification information |
| 0Ch | BT Link Key | Client device Bluetooth link key |
| 10h | Keyboard Lock | Sets device keyboard NUM lock and |
| | | CAPS lock state |
| 11h | Disconnect Request | Request a device disconnect or |
| | | warning message |
| 14h | Current Date | Sends current date information |

When operation identifier 70 shown in FIG. 3 identifies the mouse report command, the packet instructs the receiver to update its local cursor position and to provide button status information, including scrolling information from a mouse wheel, if present.

Table 4 below presents descriptions of operation specific parameters 76 for the mouse report.

TABLE 4
Mouse Report Operation Parameter Data

| No. of | | |
|---|---|---|
| Bits | Content | Details |
| 10 | Absolute Y position | Identifies Y position of mouse |
| 10 | Absolute X position | Identifies X position of mouse |
| 4 | Button state bits | Bit 0 - button 1 state (0 up/1 down) |
| | | Bit 1 - button 2 state (0 up/1 down) |
| | | Bit 2 - button 3 state (0 up/1 down) |
| | | Bit 3 - button 4 state (0 up/1 down) |
| 8 | Wheel data (+127/−128) | |

When operation identifier 70 identifies the keyboard report command, the packet instructs the receiver to update its local keyboard input buffer and to provide shift state information for the Ctrl/Alt/Shift key modifiers.

Table 5 below presents descriptions of operation specific parameters 76 for the keyboard report.

TABLE 5
Keyboard Report Operation Parameter Data

| No. of | | |
|---|---|---|
| Bits | Content | Details |
| 8 | HID key code | One of the key codes defined in the USB HID |
| | | Usage Table, usage page 7 at www.usb.org. |
| 8 | Reserved | Reserved |
| 1 | Key down flag | Indicates whether a key is down or up |
| 2 | Key side | Indicates side of key board where key is |
| | | located |
| 13 | Reserved | Reserved |

When operation identifier 70 identifies the media notification command, the packet instructs the receiver that a uniquely identified mass storage device has been attached or removed from the remote device. This operation employs data payload 50 to provide additional parameter data that follows the normal operation specific parameters 76 of the header. The size in bytes of data payload 50 is depicted in payload-size indicator 72 of dominate header 60.

Table 6 below presents descriptions of payload data parameters for the media notification command.

TABLE 6
Media Notification Extended Data Parameters

| No. of | | |
|---|---|---|
| Bits | Content | Details |
| 32 | Unique media ID | Unique identifier for the media device |
| 32 | Number of Sectors | Number of sectors available on media |
| | | device |
| 24 | Sector Size | Size of sector on media device |
| 1 | Insert/Remove flag | Flag specifying if media device is inserted |
| | | or removed. 1 = inserted, 0 = removed. If |
| | | flag set to removed, only Unique Media |
| | | ID parameter required |
| 1 | Read-only flag | Flag specifying if media device is read- |
| | | only or read/write capable. 1 = read only, |
| | | 0 = read/write. |
| 6 | Reserved | Reserved |

When operation identifier 70 identifies the battery status command, the packet instructs the receiver to update its remote device battery status indicators. This command is sent to provide battery status from the remote device for use by the receiver (e.g., for monitoring).

The operation specific parameters 76 for the battery status command include 2 bits identifying the battery number being reported, 6 bits of reserved data, 16 bits identifying the battery level and 8 bits of reserved data. The battery level is a 16 bit value normalized from 0 to 65535. The receiver should treat this value as a percentage of battery capacity available with the following formula: percentage=(Battery Level*100)/65536. A battery value of 99% can be considered full, while a value of 10% or less can be considered critically low.

When the operation identifier 70 identifies the screen resolution command, the packet instructs the remote device to change to a specified display resolution. The operation specific parameters 76 for the screen resolution command includes 12 bits identifying the width of the adjusted screen and 12 bits identifying the height of the adjusted screen, with the remaining 8 bits being reserved. The value for the width of the adjusted screen is in the range between, for example, 800 and 1024, while the value for the height of the adjusted screen is in the range between, for example, 480 and 768.

When the operation identifier 70 identifies the power management command, the packet instructs the remote device to update its power management settings, including time-outs associated with various screen dim modes and sleep modes. This operation employs data payload 50 to provide additional parameter data that follows the normal operation specific parameters 76 of the header. The size in bytes of data payload 50 is depicted in payload-size indicator 72 of dominate header 60.

Table 7 below presents descriptions of payload data parameters for the power management command.

TABLE 7
Power Management Extended Data Parameters

| No. of | | |
|---|---|---|
| Bits | Content | Details |
| 32 | On battery time to DIM | Expressed in milliseconds |
| 32 | On battery time to Sleep | Expressed in milliseconds |
| 32 | On battery Screen Brightness | Screen brightness range |
| | | expressed from 20-251 |
| 32 | On battery Sleep or Off | Expressed as a Boolean |
| 32 | On external Power time to DIM | Expressed in milliseconds |
| 32 | On external Power time to Sleep | Expressed in milliseconds |
| 32 | On external Power Brightness | Screen brightness range |
| | | expressed from 20-251 |
| 32 | On external Power Sleep or OFF | Expressed as a Boolean |

When the operation identifier 70 identifies the input settings command, the packet instructs the remote device to update its input device settings, including key delay, key repeat and mouse speed. This operation employs data payload 50 to provide additional parameter data that follows the normal operation specific parameters 76 of the header. The size in bytes of data payload 50 is depicted in payload-size indicator 72 of dominate header 60.

Table 8 below presents descriptions of payload data parameters for the input settings command.

TABLE 8
Input Settings Extended Data Parameters

| No. of | | |
|---|---|---|
| Bits | Content | Details |
| 8 | Touchpad | Touchpad speed and acceleration setting range |
| | speed | expressed from 0-255. |
| 6 | Reserved | Reserved |
| 1 | Touchpad | Touchpad tap disable flag. 1 = tapping disabled, |
| | tap disable | 0 = enabled. |
| 1 | Touchpad | Touchpad disable flag. 1 = disabled, 0 = |
| | disable | enabled. |
| 8 | Key delay | Keyboard delay value expressed from 1 to 25 in |
| | | 10s of milliseconds. Used as keyboard key delay |
| | | time before key pressed is repeated. |
| 8 | Key repeat | Keyboard key repeat value expressed from 1 to |
| | | 50. Lower values equate to longer delays for key |
| | | repeat (e.g. 1 = 1 second delay, 50 = 20 |
| | | millisecond delay). |

When the operation identifier 70 identifies the cursor control command, the packet instructs the remote device to update its input cursor to one of the predefined shapes, including the conventional “arrow”, etc. The operation specific parameters 76 for the cursor control command include 8 bits identifying the cursor type and 24 bits of reserved data. For example, a hexadecimal value of 00 in the first 8 bits may represent a standard arrow cursor shape, a hexadecimal value of 01 may represent a horizontal drag cursor shape, a hexadecimal value of 02 may represent a vertical drag cursor shape, a hexadecimal value of 03 may represent a diagonal drag cursor shape, and a hexadecimal value of 04 may represent no visible cursor on the screen.

When the operation identifier 70 identifies the unit info command, the packet conveys the remote device's unique Bluetooth hardware device address to the receiver. This operation employs data payload 50 to provide additional parameter data that follows the normal operation specific parameters 76 of the header. The size in bytes of data payload 50 is depicted in payload-size indicator 72 of dominate header 60. In particular, this operation employs 24 bits to identify the Bluetooth special interest group (SIG) manufacturer identification and 24 bits to identify the unit serial number. The Bluetooth SIG manufacturer identification is a uniquely assigned identification of the host device. The unit serial number is a unique number of the remote host device and is the same serial number used in the unit serial number field of the remote discovery packet. The combination of the Bluetooth SIG manufacturer identification and the unit serial number forms the host Bluetooth hardware device address.

When the operation identifier 70 identifies the BT link key command, the packet conveys the unique link key of the host device and device name to the client. This operation employs data payload 50 to provide additional parameter data that follows the normal operation specific parameters 76 of the header. The size in bytes of data payload 50 is depicted in payload-size indicator 72 of dominate header 60. Particularly, this operation employs 48 bits to identify the Bluetooth hardware device address, as defined above, 128 bits to identify the Bluetooth link key, and 320 bits to identify the name of the link key and the Bluetooth device.

When the operation identifier 70 identifies the keyboard lock command, the packet instructs the remote device to update its NUM lock and CAPS lock state. The operation specific parameters 76 for the keyboard lock command include 8 bits flagging a keyboard lock and 24 bits of reserved data. For example, a hexadecimal value of 20 in the first 8 bits may indicate that the number lock state will be modified. A hexadecimal value of 10 may indicate that the caps lock state will be modified. A hexadecimal value of 02 may indicate that the number lock state is locked, wherein the number lock is cleared if the bit is clear and the number lock is ignored if the number lock modify is not set. A hexadecimal value of 01 may indicate that the caps lock state is to be locked, wherein the caps lock is cleared if the bit is clear and the caps lock is ignored if the caps lock modify is not set.

When the operation identifier 70 identifies the disconnect request command, the packet instructs the client that it should disconnect or display a warning that a potential disconnection may occur. This command is primarily used to notify the client that the host is low on memory. The operation specific parameters 76 for the disconnect request command includes 8 bits identifying a reason for disconnecting and 24 bits of reserved data. For example, a hexadecimal value of 01 in the first 8 bits may indicate that the host is low on memory.

When the operation identifier 70 identifies the current date command, the packet conveys the current date of the host device to the client. The operation specific parameters 76 for the disconnect request command includes 8 bits identifying the year, 8 bits identifying the month, 8 bits identifying the day and 8 bits of reserved data. The year value is expressed in a range of 0-99 with a year 2000 base, the month value is expressed in a range of 1-12, and the day value is expressed in a range of from 1-31.

Turning now to the packet format for video raster commands. The dominant header 60 includes the raster operation in the operation identifier 70 and the payload size. The operation specific parameters 76 of the video raster formatted packet header is 12 bytes in size. The video raster operation parameters are typically shared by each of the defined raster operations. In some cases, parameters will be interpreted differently from raster operation to raster operation.

Table 9 below presents descriptions of various operations identified by the operation identifier 70 for the video raster formatted packet header.

TABLE 9
Command Operations usable with Video Raster formatted packet

| BYTE | | |
|---|---|---|
| VALUE | NAME | FUNCTION |
| 00h | Null | Sent as null operation |
| 01h | Fill Screen | Clears screen buffer with a color |
| 02h | Rectangle | Draws filled or unfilled rectangle with color and mix |
| | | operation |
| 03h | Horizontal Line | Draws horizontal line with color and mix operation |
| 04h | Vertical Line | Draws vertical line with color and mix operation |
| 05h | Raw 16bpp Color | Draws 16bit per pixel color image with mix operation |
| | Image Blit | |
| 06h | Compressed Image Blit | Draws compressed color image with compression type |
| | | and mix operation |
| 07h | Screen Buffer Copy | Copies screen buffer section with mix operation |
| 08h | Screen Buffer Tile | Copies screen buffer section and repeats n times |
| | | horizontally and n times vertically |
| 09h | Screen Buffer Copy | Copies screen buffer section with single color |
| | Transparent | transparency and mix operation |
| 0Ah | Invert Destination | Inverts bits of a screen buffer section |
| 0Bh | Raw 1bpp Color Image | Draws 1bit per pixel color image. |
| | Blit | |
| 0Fh | Synchronize | Sent as synchronization packet during idle time |

When operation identifier 70 identifies the null video operation, the packet sends a NOOP to the decoder. This operation is used primarily by the decoder to internally terminate a list of raster operations. All the bytes of operation specific parameter 76 are set to zero for this operation.

When operation identifier 70 identifies the fill screen operation, the packet instructs the decoder to fill a screen buffer with a specified color. This operation fills the entire screen buffer, up to the size of the screen buffer of the decoder.

Table 10 below presents descriptions of operation specific parameters 76 for the fill screen operation.

TABLE 10
Fill Screen Operation Parameter Data

| No. of | | |
|---|---|---|
| Bits | Content | Details |
| 2 | Destination screen | Zero-based screen buffer index of destination |
| | buffer ID (low bits) | screen buffer (0-15). This value is valid to |
| | | Video Buffers Count −1 (as specified in the |
| | | discover packet). An ID value of 0 is the |
| | | visible display buffer. |
| 70 | Reserved | Reserved |
| 16 | Fill color | Fill color used to fill screen. Color format is |
| | | 5 bits of red, 6 bits of green, and 5 bits of |
| | | blue. |
| 2 | Destination screen | Same as Destination screen buffer ID above. |
| | buffer ID (high bits) | |
| 2 | Reserved | Reserved |
| 4 | Constant hexadecimal | Hexadecimal value = 4 |
| | value of 4 | |

When operation identifier 70 identifies the rectangle video operation, the packet instructs the decoder to draw a rectangular border that is either filled or unfilled with a specified color and a source and destination mix operation.

Table 11 below presents descriptions of operation specific parameters 76 for the rectangle operation.

TABLE 11
Rectangle Operation Parameter Data

| No. of | | |
|---|---|---|
| Bits | Content | Details |
| 2 | Destination screen | Zero-based screen buffer index of destination |
| | buffer ID (low bits) | screen buffer (0-15). This value is valid to |
| | | Video Buffers Count −1 (as specified in the |
| | | discover packet). An ID value of 0 is the |
| | | visible display buffer. |
| 10 | Destination X position | Start X position of rectangle operation. |
| 10 | Destination Y position | Start Y position of rectangle operation. |
| 10 | Destination width | X position width of rectangle operation. All |
| | | width values interpreted as 1-1024 (decoded |
| | | as Destination width +1). |
| 10 | Destination height | Y position height of rectangle operation. All |
| | | height values interpreted as 1-1024 (decoded |
| | | as Destination height +1). |
| 1 | Filled | Flag specifying if rectangle operation fills |
| | | entire area of rectangle or just single pixel |
| | | border. 1 = filled, 0 = not filled. |
| 2 | Reserved | Reserved |
| 3 | Mix operation | Hexadecimal value of 0-4. 0 = copy color of |
| | | source pixel to destination pixel. 1 = mix |
| | | color of source pixel to destination pixel using |
| | | XOR operation. 2 = mix color of source pixel |
| | | to destination pixel using AND operation. 3 = |
| | | mix color of source pixel to destination pixel |
| | | using OR operation. 4 = invert color of source |
| | | pixel and copy to destination pixel. |
| 24 | Reserved | Reserved |
| 16 | Color | Operation color. Color format is 5 bits of red, |
| | | 6 bits of green and 5 bits of blue; 16-bit value. |
| 2 | Destination screen | Same as Destination screen buffer ID above. |
| | buffer ID (high bits) | |
| 2 | Reserved | Reserved |
| 4 | Constant hexadecimal | Hexadecimal value = 4 |
| | value of 4 | |

When operation identifier 70 identifies the horizontal line video operation, the packet instructs the decoder to draw a horizontal line with a specified color and a source and destination mix operation. Similarly, when operation identifier 70 identifies the vertical line video operation, the packet instructs the decoder to draw a vertical line with a specified color and a source and destination mix operation.

Table 12 below presents descriptions of operation specific parameters 76 for the horizontal line and vertical line operations. As used in Table 12, the term “line” refers to either a horizontal line or a vertical line, depending on the specific command operation identified in operation identifier 70.

TABLE 12
Horizontal and Vertical Line Operation Parameter Data

| No. of | | |
|---|---|---|
| Bits | Content | Details |
| 2 | Destination screen | Zero-based screen buffer index of destination |
| | buffer ID (low bits) | screen buffer (0-15). This value is valid to |
| | | Video Buffers Count −1 (as specified in the |
| | | discover packet). An ID value of 0 is the |
| | | visible display buffer. |
| 10 | Destination X position | Start X position of line operation. |
| 10 | Destination Y position | Start Y position of line operation. |
| 10 | Destination length | X position length of line operation |
| 13 | Reserved | Reserved |
| 3 | Mix operation | Hexadecimal value of 0-4. 0 = copy color of |
| | | source pixel to destination pixel. 1 = mix |
| | | color of source pixel to destination pixel using |
| | | XOR operation. 2 = mix color of source pixel |
| | | to destination pixel using AND operation. 3 = |
| | | mix color of source pixel to destination pixel |
| | | using OR operation. 4 = invert color of source |
| | | pixel and copy to destination pixel. |
| 24 | Reserved | Reserved |
| 16 | Color | Operation color. Color format is 5 bits of red, |
| | | 6 bits of green and 5 bits of blue; 16-bit value. |
| 2 | Destination screen | Same as Destination screen buffer ID above. |
| | buffer ID (high bits) | |
| 2 | Reserved | Reserved |
| 4 | Constant hexadecimal | Hexadecimal value = 3 |
| | value of 3 | |

When operation identifier 70 identifies the Raw 16 bpp Color Image Blit video operation, the packet instructs the decoder to draw an image with a source and destination mix operation. A pixel in this format is 2 bytes (octets) wide. The color format for a pixel is RGB with 5 bits red, 6 bits green and 5 bits blue. This 16-bit pixel value is in little-endian format. Network byte order for the image stream can be restored by swapping the contents of the 2 bytes representing the pixel value. This operation employs data payload 50 to provide image data that follows the operation specific parameters 76 of the header. The size in bytes of data payload 50 is depicted in payload-size indicator 72 of dominate header 60.

Table 13 below presents descriptions of operation specific parameters 76 for the raw 16 bpp color image blit operation.

TABLE 13
Raw 16bpp Color Image Blit Operation Parameter Data

| No. of | | |
|---|---|---|
| Bits | Content | Details |
| 2 | Destination screen | Zero-based screen buffer index of destination |
| | buffer ID (low bits) | screen buffer (0-15). This value is valid to |
| | | Video Buffers Count −1 (as specified in the |
| | | discover packet). An ID value of 0 is the |
| | | visible display buffer. |
| 10 | Destination X position | Start X position of blit operation. |
| 10 | Destination Y position | Start Y position of blit operation. |
| 10 | Destination width | X position width of blit operation. All width |
| | | values interpreted as 1-1024 (decoded as |
| | | Destination width +1). |
| 10 | Destination height | Y position height of blit operation. All height |
| | | values interpreted as 1-1024 (decoded as |
| | | Destination height +1). |
| 3 | Reserved | Reserved |
| 3 | Mix operation | Hexadecimal value of 0-4. 0 = copy color of |
| | | source pixel to destination pixel. 1 = mix |
| | | color of source pixel to destination pixel |
| | | using XOR operation. 2 = mix color of |
| | | source pixel to destination pixel using AND |
| | | operation. 3 = mix color of source pixel to |
| | | destination pixel using OR operation. |
| | | 4 = invert color of source pixel and copy to |
| | | destination pixel. |
| 40 | Reserved | Reserved |
| 2 | Destination screen | Same as Destination screen buffer ID above. |
| | buffer ID (high bits) | |
| 2 | Reserved | Reserved |
| 4 | Constant hexadecimal | Hexadecimal value = 4 |
| | value of 4 | |

When operation identifier 70 identifies the Compressed Image Blit video operation, the packet instructs the decoder to decompress and draw an image with a source and destination mix operation and specified compressed pixel format type. The Image data is appended to the packet header after operation specific parameters 76 with the image size specified in the payload-size indicator 72 of dominate header 60.

Table 14 below presents descriptions of operation specific parameters 76 for the compressed image blit operation.

TABLE 14
Compressed Image Blit Operation Parameter Data

| No. of | | |
|---|---|---|
| Bits | Content | Details |
| 2 | Destination screen | Zero-based screen buffer index of destination |
| | buffer ID (low bits) | screen buffer (0-15). This value is valid to |
| | | Video Buffers Count −1 (as specified in the |
| | | discover packet). An ID value of 0 is the |
| | | visible display buffer. |
| 10 | Destination X position | Start X position of blit operation. |
| 10 | Destination Y position | Start Y position of blit operation. |
| 10 | Destination width | X position width of blit operation. All width |
| | | values interpreted as 1-1024 (decoded as |
| | | Destination width +1). |
| 10 | Destination height | Y position height of blit operation. All height |
| | | values interpreted as 1-1024 (decoded as |
| | | Destination height +1). |
| 1 | Reserved | Reserved |
| 2 | Compression Type | Hexadecimal value of 0 = Simple RLE |
| | | compression algorithm. |
| 3 | Mix operation | Hexadecimal value of 0-4. 0 = copy color of |
| | | source pixel to destination pixel. 1 = mix |
| | | color of source pixel to destination pixel |
| | | using XOR operation. 2 = mix color of |
| | | source pixel to destination pixel using AND |
| | | operation. 3 = mix color of source pixel to |
| | | destination pixel using OR operation. |
| | | 4 = invert color of source pixel and copy to |
| | | destination pixel. |
| 40 | Reserved | Reserved |
| 2 | Destination screen | Same as Destination screen buffer ID above. |
| | buffer ID (high bits) | |
| 2 | Reserved | Reserved |
| 4 | Constant hexadecimal | Hexadecimal value = 4 |
| | value of 4 | |

If the compression type field is set to the hexadecimal value of zero in the operation specific parameter 76, a simple run-length compression format is used as depicted, for example, in the following description.

The input pixel color format is 5 bits of red, 6 bits of green and 5 bits of blue in a 16-bit value. The compression algorithm will convert the pixel to a color format of 5 bits of red, 5 bits of green and 5 bits of blue. The 16-bit value in the image stream is little-endian. To restore network byte order of the pixel stream, the receiver must swap the contents of the 2 bytes of the 16-bit value. The image receiver is responsible for up converting pixel color values (e.g. converting back to 5-6-5 format).

The compressed color format of the pixel occupies 15-bits. A “free” bit in the 16-bit value is used as a command identifier. If the bit is not set, the remaining 15-bits specify the current color in 5-5-5 format. If the bit is set the remaining 15-bits are used to signify a run length of the previously set color value (2 to 32767) or if all of the remaining 15-bits are clear, the current set color is transparent (e.g. tells the decoder to not copy the source pixel in the image stream to the destination pixel).

The image stream will always declare a pixel color value as the first 16-bit value of the image stream. Pixel color values will be specified whenever a current color value changes. Run-length values will span scan lines (e.g. the run will continue to the next Y position increment in the image stream). If the run length exceeds the 32767 (hexadecimal value of 7FFF) limit of a run-length value, additional run-length values will follow. The image stream does not contain additional tokens for “end of line”, etc. The x, y, width and height parameters of the header specify the image area and bounds of the image stream.

Color values and run-length values in the stream may be configured as follows. For all byte configurations, the first bit identifies the command identification in hexadecimal value. A set color value may comprise a command identification value of 0, and 15 bits identifying the pixel color. A run length value may comprise a command identification value of 1, and 15 bits identifying the run length. A set transparent color value may comprise a command identification value of 1, and 15 bits identifying the transparent color identification.

A solid colored image can take as little as 4 bytes to represent (two 16-bit values) as in the following example where a 32×32 solid red image is coded into two 16-bit values. The first 16-bit value has a command identification of 0, 5 bits identifying red with a value of 1F, 5 bits identifying green with a value of 00, and 5 bits identifying blue with a value of 00. The second 16-bit value has a command identification of 1 and 15 bits identifying the run-length count.

When operation identifier 70 identifies the screen buffer copy video operation, the packet instructs the decoder to copy a section of one screen buffer to another screen buffer location with a source and destination mix operation.

Table 15 below presents descriptions of operation specific parameters 76 for the screen buffer copy operation.

TABLE 15
Screen Buffer Copy Operation Parameter Data

| No. of | | |
|---|---|---|
| Bits | Content | Details |
| 2 | Destination screen | Zero-based screen buffer index of destination |
| | buffer ID (low bits) | screen buffer (0-15). This value is valid to |
| | | Video Buffers Count −1 (as specified in the |
| | | discover packet). An ID value of 0 is the |
| | | visible display buffer. |
| 10 | Destination X position | Start X position of destination operation. |
| 10 | Destination Y position | Start Y position of destination operation. |
| 10 | Destination width | X position width of destination operation. |
| | | All width values interpreted as 1-1024 |
| | | (decoded as Destination width +1). |
| 10 | Destination height | Y position height of destination operation. |
| | | All height values interpreted as 1-1024 |
| | | (decoded as Destination height +1). |
| 3 | Reserved | Reserved |
| 3 | Mix operation | Hexadecimal value of 0-4. 0 = copy color of |
| | | source pixel to destination pixel. 1 = mix |
| | | color of source pixel to destination pixel |
| | | using XOR operation. 2 = mix color of |
| | | source pixel to destination pixel using AND |
| | | operation. 3 = mix color of source pixel to |
| | | destination pixel using OR operation. |
| | | 4 = invert color of source pixel and copy to |
| | | destination pixel. |
| 2 | Source screen buffer | Zero-based screen buffer index of source |
| | ID (low bits) | screen buffer (0-15). This value is valid to |
| | | Video Buffers Count −1 (as specified in the |
| | | discover packet). An ID value of 0 is the |
| | | visible display buffer. |
| 10 | Source X position | Start X position of source operation. |
| 10 | Source Y position | Start Y position of source operation. |
| 18 | Reserved | Reserved |
| 2 | Destination screen | Same as Destination screen buffer ID above. |
| | buffer ID (high bits) | |
| 2 | Source screen buffer | Same as source screen buffer ID above. |
| | ID (high bits) | |
| 4 | Constant hexadecimal | Hexadecimal value = 1 |
| | value of 1 | |

When operation identifier 70 identifies the screen buffer tile video operation, the packet instructs the decoder to copy a section of a screen buffer that repeats the copy operation n times horizontally and n times vertically. The operation increments the destination location by the width for horizontal repeats and increments the destination location by the height for vertical repeats.

Table 16 below presents descriptions of operation specific parameters 76 for the screen buffer tile operation.

TABLE 16
Screen Buffer Tile Operation Parameter Data

| No. of | | |
|---|---|---|
| Bits | Content | Details |
| 2 | Destination screen | Zero-based screen buffer index of destination |
| | buffer ID (low bits) | screen buffer (0-15). This value is valid to |
| | | Video Buffers Count −1 (as specified in the |
| | | discover packet). An ID value of 0 is the |
| | | visible display buffer. |
| 10 | Destination X position | Start X position of destination and copy |
| | | source operation. |
| 10 | Destination Y position | Start Y position of destination and copy |
| | | source operation. |
| 10 | Destination width | X position width of destination and copy |
| | | source operation. All width values |
| | | interpreted as 1-1024 (decoded as |
| | | Destination width +1). |
| 10 | Destination height | Y position height of destination and copy |
| | | source operation. All height values |
| | | interpreted as 1-1024 (decoded as |
| | | Destination height +1). |
| 8 | Reserved | Reserved |
| 10 | Horizontal repeat count | Repeat count of horizontal copy operations |
| 10 | Vertical repeat count | Repeat count of vertical copy operations |
| 18 | Reserved | Reserved |
| 2 | Destination screen | Same as Destination screen buffer ID above. |
| | buffer ID (high bits) | |
| 2 | Reserved | Reserved |
| 4 | Constant hexadecimal | Hexadecimal value = 1 |
| | value of 1 | |

When operation identifier 70 identifies the screen buffer copy video operation, the packet instructs the decoder to copy a section of one screen buffer to another screen buffer location with a source and destination mix operation and a specified transparency color. A pixel in the source screen buffer that matches the specified transparency color is not copied to the destination screen buffer.

Table 17 below presents descriptions of operation specific parameters 76 for the screen buffer copy operation.

TABLE 17
Screen Buffer Copy Operation Parameter Data

| No. of | | |
|---|---|---|
| Bits | Content | Details |
| 2 | Destination screen | Zero-based screen buffer index of destination screen buffer |
| | buffer ID (low bits) | (0-15). This value is valid to Video Buffers Count −1 (as |
| | | specified in the discover packet). An ID value of 0 is the |
| | | visible display buffer. |
| 10 | Destination X position | Start X position of destination operation. |
| 10 | Destination Y position | Start Y position of destination operation. |
| 10 | Destination width | X position width of destination operation. All width values |
| | | interpreted as 1-1024 (decoded as Destination width +1). |
| 10 | Destination height | Y position height of destination operation. All height values |
| | | interpreted as 1-1024 (decoded as Destination height +1). |
| 3 | Reserved | Reserved |
| 3 | Mix operation | Hexadecimal value of 0-4. 0 = copy color of source pixel to |
| | | destination pixel. 1 = mix color of source pixel to destination |
| | | pixel using XOR operation. 2 = mix color of source pixel to |
| | | destination pixel using AND operation. 3 = mix color of |
| | | source pixel to destination pixel using OR operation. |
| | | 4 = invert color of source pixel and copy to destination pixel. |
| 2 | Source screen buffer | Zero-based screen buffer index of source screen buffer (0-15). |
| | ID (low bits) | This value is valid to Video Buffers Count −1 (as specified in |
| | | the discover packet). An ID value of 0 is the visible display |
| | | buffer. |
| 10 | Source X position | Start X position of source operation. |
| 10 | Source Y position | Start Y position of source operation. |
| 2 | Reserved | Reserved |
| 16 | Transparency color | Transparency color of operation. Color format is 5 bits of red, |
| | | 6 bits of green and 5 bits of blue; 16-bit value. Pixel color |
| | | values in source buffer that match transparency color are not |
| | | copied to destination buffer. This evaluation performed before |
| | | mix operation is executed. |
| 2 | Destination screen | Same as Destination screen buffer ID above. |
| | buffer ID (high bits) | |
| 2 | Source screen buffer | Same as Source screen buffer ID above. |
| | ID (high bits) | |
| 4 | Constant hexadecimal | Hexadecimal value = 1 |
| | value of 1 | |

When operation identifier 70 identifies the invert destination video operation, the packet instructs the decoder to invert the bits (of a pixel) in a section of the destination screen buffer.

Table 18 below presents descriptions of operation specific parameters 76 for the invert destination operation.

TABLE 18
Invert Destination Operation Parameter Data

| No. of | | |
|---|---|---|
| Bits | Content | Details |
| 2 | Destination screen | Zero-based screen buffer index of destination |
| | buffer ID (low bits) | screen buffer (0-15). This value is valid to |
| | | Video Buffers Count −1 (as specified in the |
| | | discover packet). An ID value of 0 is the |
| | | visible display buffer. |
| 10 | Destination X position | Start X position of destination operation. |
| 10 | Destination Y position | Start Y position of destination operation. |
| 10 | Destination width | X position width of destination operation. |
| | | All width values interpreted as 1-1024 |
| | | (decoded as Destination width +1). |
| 10 | Destination height | Y position height of destination operation. |
| | | All height values interpreted as 1-1024 |
| | | (decoded as Destination height +1). |
| 3 | Reserved | Reserved |
| 3 | Constant hexadecimal | Hexadecimal value = 4 |
| | value of 4 | |
| 40 | Reserved | Reserved |
| 2 | Destination screen | Same as Destination screen buffer ID above. |
| | buffer ID (high bits) | |
| 2 | Reserved | Reserved |
| 4 | Constant hexadecimal | Hexadecimal value = 4 |
| | value of 4 | |

When operation identifier 70 identifies the raw 1 bpp color image blit video operation, the packet instructs the decoder to draw an image with a foreground color, background color and a background transparency option. If the background transparency option is set, pixels in the source image are not copied to the destination. The pixel format is 1 bit with 0 for the background color and 1 for the foreground color. The source image buffer must be padded if the entire buffer size is not a multiple of 4. This operation employs data payload 50 to provide image data that follows the operation specific parameters 76 of the header. The size (in bytes) of data payload 50 is depicted in payload-size indicator 72 of dominate header 60.

Table 19 below presents descriptions of operation specific parameters 76 for the raw 1 bpp color image blit operation.

TABLE 19
Raw 1bpp Color Image Blit Operation Parameter Data

| No. of | | |
|---|---|---|
| Bits | Content | Details |
| 2 | Destination screen | Zero-based screen buffer index of destination |
| | buffer ID (low bits) | screen buffer (0-15). This value is valid to Video |
| | | Buffers Count −1 (as specified in the discover |
| | | packet). An ID value of 0 is the visible display |
| | | buffer. |
| 10 | Destination X position | Start X position of blit operation. |
| 10 | Destination Y position | Start Y position of blit operation. |
| 10 | Destination width | X position width of blit operation. All width values |
| | | interpreted as 1-1024 (decoded as Destination width +1). |
| 10 | Destination height | Y position height of blit operation. All height |
| | | values interpreted as 1-1024 (decoded as |
| | | Destination height +1). |
| 1 | Use background color | Instructs decoder to use background color specified |
| | | in image or to treat source color pixels that match |
| | | background color to be transparent and not copied |
| | | to destination buffer. 1 = use background color, 0 = |
| | | transparent background. |
| 13 | Reserved | Reserved |
| 16 | Background color | Background color of operation. Color format is 5 |
| | | bits of red, 6 bits of green and 5 bits of blue; 16-bit |
| | | value. Color index zero for 1 bit per pixel image |
| | | data. If pixel bit is not set in image stream, this |
| | | color will be used. |
| 16 | Foreground color | Foreground color of operation. Color format is 5 |
| | | bits of red, 6 bits of green and 5 bits of blue; 16-bit |
| | | value. Color index one for 1 bit per pixel image |
| | | data. If pixel bit is set in image stream, this color |
| | | will be used. |
| 2 | Destination screen | Same as Destination screen buffer ID above. |
| | buffer ID (high bits) | |
| 2 | Reserved | Reserved |
| 4 | Constant hexadecimal | Hexadecimal value = 2 |
| | value of 2 | |

When operation identifier 70 identifies the synchronize video operation, the packet instructs the decoder to resynchronize, if needed. The operation is sent during idle time (e.g., when no other video operations are scheduled). All 12 bytes in the operation specific parameters 76 for the synchronize operation are set to the hexadecimal value FF.

Turning now to the packet format for mass storage commands. The dominant header 60 includes the block operation in the operation identifier 70 and the payload size. The operation specific parameters 76 of the mass storage formatted packet header is 12 bytes in size.

Table 20 below presents descriptions of various operations identified by operation identifier 70 for the mass storage formatted packet header.

TABLE 20
Command Operations usable with Mass Storage formatted packet

| BYTE | | |
|---|---|---|
| VALUE | NAME | FUNCTION |
| 02h | Block Read | Requests remote device to return |
| | Request | requested bytes from storage device |
| 04h | Block Write | Requests remote device to receive |
| | Request | requested bytes to storage device |
| 05h | IO Request | Sent or received by remote device to |
| | Complete | convey transfer status and completion |

When operation identifier 70 indicates the block read request command, the packet requests that the remote device return a specified amount of data from a storage device. The storage device is uniquely identified and the start location and requested transfer size are included. In particular, the operation specific parameters 76 for the block read request command includes 32 bits indicating the unique identifier for the media device, 32 bits indicating the sector number where starting data will be read from the media device, and 32 bits indicating the amount of data to be read in bytes from the start sector.

When operation identifier 70 indicates the block write request command, the packet requests that the remote device writes a specified amount of data to a storage device. The storage device is uniquely identified and the start location. In particular, the operation specific parameters 76 for the block write request command includes 32 bits indicating the unique identifier for the media device, and 32 bits indicating the sector number where starting data will be written to the media device. The block write operation employs data payload 50 to provide write data that follows the operation specific parameters 76 of the header. The size (in bytes) of data payload 50 is depicted in payload-size indicator 72 of dominate header 60.

When operation identifier 70 indicates the IO request complete command, the packet acknowledges or fails requests and transfers as they are occurring. The IO request complete command is sent immediately following a block read request (to fulfill the requested data) or a block write request (to acknowledge the request) and is also interspersed with both block read and block write requests every 2 kilobytes.

The operation specific parameters 76 for the IO request complete command includes 32 bits indicating the unique identifier for the media device, 1 bit consisting of a flag specifying that a requested operation failed or was successful, and 31 bits that are reserved. The flag may be configured so that a 1 indicates that the operation failed and a 0 indicates that the operation was successful. The IO request complete operation employs data payload 50 to provide read data that was the result of a block read request operation. Data payload 50 follows the operation specific parameters 76 of the header. The size (in bytes) of data payload 50 is depicted in payload-size indicator 72 of dominate header 60. When the IO request complete operation is used in conjunction with a block write request operation, it serves only as an acknowledgement that data was successfully written to the media device and no data payload 50 will be present. Therefore, the value of payload-size indicator 72 will always be zero when used as a write request acknowledgment.

Table 21 below is an example of computer code describing the packet exchange for reading from a client device.

TABLE 21
Pseudo Code for Client Device to read from Host Device Memory

```
Begin:
  Send Block Read Request Packet header (requesting 4K bytes from
  media device)
  Wait to receive IO Request Complete packet header
  If fail (Failed flag set in IO Request Complete packet) goto Failed
  Receive extended data bytes (first 2K bytes of transfer)
  Wait to receive IO Request Complete packet header
  If fail (Failed flag set in IO Request Complete packet) goto Failed
  Receive extended data bytes (remaining 2K bytes of transfer)
  ; transfer complete
Done:
  Exit routine
Failed:
  Handle read error
  Exit routine
End:
```

Table 22 below is an example of computer code describing the packet exchange for writing to a client device.

TABLE 22
Pseudo Code for Client Device to write to Host Device Memory

```
Begin:
  Send Block Write Request Packet header (requesting 4K bytes to
  media device).
  Wait to receive IO Request Complete packet header
  If fail (Failed flag set in IO Request Complete packet) goto Failed
  Send extended data bytes (first 2K bytes of transfer)
  Wait to receive IO Request Complete packet header
  If fail (Failed flag set in IO Request Complete packet) goto Failed
  Send extended data bytes (remaining 2K bytes of transfer)
  Wait to receive IO Request Complete packet header
  If fail (Failed flag set in IO Request Complete packet) goto Failed
  ; transfer complete
Done:
  Exit routine
Failed:
  Handle write error
  Exit routine
End:
```

The criteria applicable to host device 16 and to executable code 46 in memory structure 44 thereof will be discussed.

To create a compatible client platform that uses the remote protocol in a working client system, the client may, for example, be able to communicate within the TCP/IP protocol with the ability to send and receive UDP broadcast packets and reliable packet data using TCP. The client must be able at a minimum to communicate with a host device using TCP/IP. The client must also be able to buffer, at a minimum, 320K bytes of data when receiving video raster packets that include extended data, such as image data. The client must be able to provide raster display functionality that can suitably support the video raster command set defined by the remote protocol. The raster command set can address screen buffer memory at a resolution of 1024×1024. In order to comply with these capabilities, the client must support a minimum of 6 screen buffers and a visible display with an individual resolution of 1024×1024 at 16 bits per pixel. The client must be able to combine the contents of a screen buffer with the same screen buffer or separate screen buffer using the XOR, AND, and OR operations, and to handle overlapping screen buffer copies. The client must be able to format the visible display in 800×480 screen mode and support the following: 800×600 screen mode; 1024×600 screen mode; and 1024×768 screen mode. The client must be able to supply input device data to the host device, including absolute mouse position data, button event data, and keyboard key press events at a minimum. The client must be able to completely receive and dispatch incoming remote protocol packet data, including any specified extended data, discarding operations that are not recognized. The later can be accomplished by examining the operation identifier of the packet header.

Beyond the essentials mentioned above, it is recommended that the host should use a trustworthy sockets API implementation to facilitate TCP/IP communication. The host should also have the ability to use separate threads of execution, such as posix pthreads and the like, to service incoming packet data efficiently.

To communicate correctly with a remote protocol host device, and assuming the minimum transfer protocol to be TCP/IP, the client must support, at a minimum, the following command channel packet procedures:
(a) sending a mouse report command packet to the host, a. message sent whenever local pointing device data needs to be updated for the host device;
(b) sending a keyboard report command packet to the host, a. message sent whenever local pointing device data needs to be updated for the host device;
(c) sending a keyboard lock command packet to the host, a message sent whenever the local keyboard CAPS-lock or NUM-lock state has changed;
(d) receiving and acting on a screen resolution command packet, relative to which the client must reformat the viewable area of the visible display according to the dimensions received, the dimensions never being larger than the screen mode requested by the client as specified in the screen mode field of the discovery packet; and
(e) sending a media notification command to the host; the message sent whenever a supported media device is attached or detached.
   The last of the above-listed command channel packet procedures is needed only if mass storage capabilities are to be used, such as when the connection features field of the discovery packet specifies the use mass storage option. In such cases, the client is required to generate a unique identifier for each media device and to maintain that unique identifier for life of the device, or until the device is detached.

To communicate correctly with a remote protocol client device, the client must support, at a minimum, the following video raster channel packet procedures:
(a) receiving and acting on the rectangle operation, supporting the specified operation parameters;
(b) receiving and acing on the horizontal line operation, supporting the specified operation parameters;
(c) receiving and acing on the vertical line operation, supporting the specified operation parameters;
(d) receiving and acing on the raw 16 bpp color image blit operation, supporting the specified operation parameters and the image data that is expressed as extended data to the packet header;
(e) receiving and acing on the compressed image blit operation, supporting the specified operation parameters and the image data that is expressed as extended data to the packet header; and
(f) receiving and acing on the screen buffer copy operation, supporting the specified operation parameters;
(g) receiving and acing on the screen buffer tile operation, supporting the specified operation parameters;
(h) receiving and acing on the screen buffer copy transparent operation, supporting the specified operation parameters;
(i) receiving and acing on the screen buffer copy transparent operation, supporting the specified operation parameters;
(j) receiving and acing on the invert destination operation, supporting the specified operation parameters; and
(k) receiving and acing on the raw 1 bpp color image blit operation, supporting the specified operation parameters and the image data expressed as extended data to the packet header.

If mass storage capabilities are used, the client must support, at a minimum, the following mass storage channel packet procedures:
(a) receiving and acing on the block read request command, supporting the specified operations;
(b) receiving and acing on the block write request command, supporting the specified operations; and
(c) receiving and acing on the 10 request complete command, supporting the specified operations.

A summary follows of RNDIS for USB protocol.

The RNDIS for USB protocol is a NDIS transport developed by Microsoft®. The RNDIS specification is publicly available from Microsoft. The remote protocol does not, in essence, require RNDIS. It is briefly described below, as the remote protocol can take advantage of the RNDIS for USB transfer protocol as it encapsulates TCP/IP networking over USB and is widely used to interface to Microsoft Windows Mobile® devices over USB.

For USB, the RNDIS USB transport uses the abstraction control model defined by the USB Communication Device Class (CDC) version 1.1. CDC version 1.1, defines two interfaces; a communication interface and a data interface. Over USB, the interfaces are mapped to the following USB endpoints:
(a) communication class interface, which uses a single endpoint for event notification;
(b) control endpoint for control messages, which is shared and bi-directional; and
(c) data class interface using 2 bulk endpoints for data traffic, IN bulk EP and OUT bulk EP.
   As stated by Microsoft, the RNDIS specification eliminates the need for an OEM miniport driver in the host machine and provides a protocol to remote the NDIS miniport driver implementation to the remote device.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed is:

1. A method for communicating data among elements of a host device and elements of a client device, operation of the host device in concert with the client device making a feature of the client device available to the host device, the method comprising the steps of:
(a) identifying data categories where among to allocate all data payloads communicated among the elements of the host device and the client device based on a data processing to be function performed involving each respective data payload;
(b) associating individual dedicated communication channels in a set thereof with each data category;
(c) defining a data processing header for each dedicated communication channel, the data processing header for each dedicated communication channel including particulars sufficient to support a data processing operation;
(d) commencing each data payload with the data processing header defined for the dedicated communication channel associated with the data category of data in the data payload; and
(d) transmitting the data payload with the data processing header attached thereto on the dedicated communication channel associated with the data category of data in the data payload.

2. A method as recited in claim 1, wherein the size of the data processing header for a given dedicated communication channel is independent of the particular data payload communicated on the given dedicated communication channel.

3. A method as recited in claim 1, wherein the data processing header defined for each of dedicated communication channel comprises:
(a) a dominant header of a size common to all data processing headers; and
(b) a subdominant header, the size of the subdominant header for a given dedicated communication channel being independent of the particular data payload communicated on the given dedicated communication channel.

4. A method as recited in claim 3, wherein the dominant header of each data processing header comprises:
(a) an operation identifier explicating the purpose of the data payload following the data processing header; and
(b) a payload-size indicator conveying the size of any data in the data payload following the data processing header.

5. A method as recited in claim 1, wherein the data payload following the data processing header is devoid of data.

6. A method as recited in claim 1, wherein the set of dedicated communication channels comprise:
(a) a command channel whereupon keyboard and mouse event data payloads are transferred;
(b) a video raster channel whereupon raster display operations are transferred; and
(c) a mass storage channel whereupon mass storage media block data is transferred.

7. A method as recited in claim 1, wherein the step of transmitting comprises the steps of:
(a) contacting the host device from the client device offering to conduct a data exchange;
(b) accepting the offer to conduct a data exchange by the host device;
(c) interconnecting the client device with the host device; and
(d) communicating the data payload with the data processing header attached thereto between the host device and the client device.

8. A method as recited in claim 8, wherein the step of contacting comprises the steps of:
(a) broadcasting from the client device a discovery packet seeking to have the client device placed in communication with the host device; and
(b) receiving the discovery payload at the host device.

9. A method as recited in claim 8, wherein the step of interconnecting comprises the steps of:
(a) connecting the client device to the host device; and
(b) coupling the host device to the client device.

10. A method as recited in claim 1, wherein the host device is a device selected from the group of devices comprising a cellular phone, a smart phone, a personal digital assistant, an electronic book, and a personal media player.

11. A method for packetizing and communicating data among elements of a data processing system, the method comprising the steps of:
(a) organizing the data into data payloads;
(b) associating individual dedicated communication channels from a set thereof with individual data categories where among are allocated all data payloads based on a data processing function to be performed involving each data payload;
(b) attaching to the leading end of the data payload a data processing header including particulars sufficient to support a data processing operation involving the data payload, the size of the data processing header for a given dedicated communication channel being independent of the particular data payload communicated on the given dedicated communication channel; and
(d) transmitting the data payload with the data processing header attached thereto on the dedicated communication channel associated with the data category of the data contained in the data payload.

12. A method as recited in claim 11, wherein the step of attaching comprises the steps of:
(a) positioning at the leading end of the data payload an operation parameters field having a size independent of the particular data payload communicated on the dedicated channel corresponding to the category of data of the type contained in the data payload, the operation parameters field advising of conditions associated with data processing operations involving data in the data category of the data contained in the data payload;
(b) locating at the leading end of the operation parameters field a payload-size indicator conveying the size of the data in the data payload; and
(c) disposing at the leading end of the payload-size indicator an operational identifier explicating the purpose of the data payload.

13. A method as recited in claim 12, wherein the operation identifier and the payload size field in combination function as a dominant portion of the data processing header, and the size of the dominant portion of the data processing header is independent of the particular data payload communicated on the given dedicated communication channel.

14. A method as recited in claim 11, wherein the set of dedicated communication channels comprises:
(a) a command channel whereupon keyboard and mouse event data payloads are transferred;
(b) a video raster channel whereupon raster display operations are transferred; and
(c) a mass storage channel whereupon mass storage media block data is transferred

15. A method as recited in claim 13, wherein a data processing header is defined for each of the dedicated communication channels, and the size of the data processing header for a given dedicated communication channel is independent of the particular data payload communicated on the given dedicated communication channel.

16. A host device operable in concert with a client device to make a feature of the client device available to the host device, the host device comprising:
(a) a communication module capable of engaging in data stream communications with the client device;
(b) a processor coupled to the communication module; and
(c) a memory structure accessible to the processor, the memory structure housing executable code operative on the processor to cause the processor to configure data for transmission to the client device as a data payload immediately preceded by a data processing header, the data processing header being definitive of an individual dedicated communication channel in a set thereof, each dedicated communication channel being associated with data categories where among are allocated all data payloads based on a data processing function to be performed involving each respective data payload.

17. A host device as recited in claim 16, wherein the data processing header comprises:
(a) an operation identifier explicating the purpose of the data payload following the data processing header;
(b) a payload-size indicator following the operation identifier, the payload-size indicator conveying the size of any data in the data payload following the data processing header; and
(c) an operation parameters segment following the payload-size indicator, the operation parameters segment advising of conditions associated with data processing operations involving data of the category of data contained in the data payload and transmitted on the dedicated communication channel corresponding thereto.

18. A host device as recited in claim 17, wherein the operation identifier and the payload-size indicator together function as a dominant portion of the data processing header, and the size of the dominant portion of the data processing header is independent of the particular data payload communicated on the dedicated communication channel corresponding to the category of data contained in the data payload.

19. A host device as recited in claim 16, wherein the set of dedicated communication channels comprise:
(a) a command channel whereupon keyboard and mouse event data payloads are transferred;
(b) a video raster channel whereupon raster display operations are transferred; and
(c) a mass storage channel whereupon mass storage media block data is transferred.

20. A host device as recited in claim 16, wherein the size of the data processing header defined for each of the dedicated communication channels is independent of the particular data payload communicated on the given dedicated communication channel.

21. A host device as recited in claim 16, wherein the data payload preceded by the data processing header is empty.
